(19) United States
(12) Patent Application Publication
(10) Pub. No.: US 2026/0124930 A1
(43) Pub. Date: May 7, 2026

(54) VEHICLE CONTROL DEVICE, VEHICLE CONTROL METHOD, AND STORAGE MEDIUM

(71) Applicant: TOYOTA JIDOSHA KABUSHIKI KAISHA, Toyota-shi (JP)

(72) Inventor: Yuma ITO, Obu-shi (JP)

(73) Assignee: TOYOTA JIDOSHA KABUSHIKI KAISHA, Toyota-shi (JP)

(21) Appl. No.: 19/185,647

(22) Filed: Apr. 22, 2025

(30) Foreign Application Priority Data
Oct. 2, 2024 (JP) 2024-172932

(51) Int. Cl. B60L 15/38; B60W 30/09; B60W 30/095; B60W 30/165

(52) U.S. Cl. CPC B60L 15/38; B60W 30/09; B60W 30/095; B60W 30/165; B60W 2554/4029; B60W 2554/4041

(57) ABSTRACT

The vehicle control device includes a forward information acquisition device that acquires forward information regarding a situation ahead of the host vehicle, and a controller that executes a following travel control for matching a distance between the host vehicle and a following target object located ahead of the host vehicle to a target distance based on the forward information. The following travel control includes acceleration control for accelerating the host vehicle, deceleration control for decelerating the host vehicle, and constant speed control for maintaining the speed of the host vehicle at a constant speed. The controller does not perform the acceleration control in the following travel control when the forward information indicates that the pedestrian is present in the predicted traveling region of the host vehicle in front of the host vehicle and the pedestrian is selected as the following target object during the execution of the following travel control.

### CROSS-REFERENCE TO RELATED APPLICATION

This application claims priority to Japanese Patent Application No. 2024-172932 filed on Oct. 2, 2024. The disclosure of the above-identified application, including the specification, drawings, and claims, is incorporated by reference herein in its entirety.

### BACKGROUND

### 1. Technical Field

The present disclosure relates to a vehicle control device, a vehicle control method, and a storage medium that execute driving assistance control for assisting a driver in driving a vehicle.

### 2. Description of Related Art

An example of a related-art vehicle control device is a device described in Japanese Unexamined Patent Application Publication No. 2008-71087 (JP 2008-71087 A). In this related-art device, when a pedestrian is present ahead of a host vehicle, the danger level of the pedestrian is calculated. When the calculated danger level is high, the speed of the host vehicle (host vehicle speed) is limited to a predetermined speed or lower or the host vehicle speed is reduced.

### SUMMARY

However, the related-art device may accelerate the host vehicle when the danger level is low even though the pedestrian is detected. Therefore, when the host vehicle suddenly approaches the pedestrian and the danger level increases as a result, the related-art device may decelerate the host vehicle. That is, the related-art device accelerates or decelerates the host vehicle when the pedestrian is present ahead of the host vehicle. Therefore, the related-art device may give an anxiety or a sense of discomfort to an occupant of the host vehicle.

The present disclosure has been made to solve this issue. In some cases, a pedestrian is located ahead of the host vehicle during the execution of the driving assistance control. An object of the present disclosure is to provide a vehicle control device, a vehicle control method, and a storage medium that can reduce a possibility of giving an anxiety or a sense of discomfort to the occupant of the host vehicle while improving safety in such cases.

A vehicle control device according to an aspect of the present disclosure includes a forward information acquisition device (20, 30) configured to acquire forward information related to a state ahead of a host vehicle, and a controller (10) configured to execute driving assistance control including acceleration control for accelerating the host vehicle and deceleration control for decelerating the host vehicle (S325, S350).

During execution of the driving assistance control, the acceleration control may be executed even when a pedestrian is present ahead of the host vehicle. Therefore, the host vehicle may suddenly approach the pedestrian, and then the deceleration control may be executed.

Therefore, the controller is configured not to execute the acceleration control (S330 to S340) when the forward information indicates that a pedestrian is located ahead of the host vehicle during execution of the driving assistance control (S230, S240).

According to this aspect, the acceleration control in the driving assistance control is not executed when a pedestrian is present ahead of the host vehicle during the execution of the driving assistance control. Therefore, the host vehicle does not suddenly approach the pedestrian ahead of the host vehicle. Thus, when the pedestrian is present ahead of the host vehicle, there is a lower possibility that the deceleration control is executed immediately after the acceleration control is executed. Accordingly, the vehicle control device of the above aspect can improve safety and reduce the possibility of giving an anxiety or a sense of discomfort to an occupant of the host vehicle.

In the vehicle control device according to the aspect of the present disclosure,
the controller is configured to, as the driving assistance control, select an object located in a predicted traveling region ahead of the host vehicle where the host vehicle is predicted to travel as a following target object (S220), and execute, based on the forward information, following travel control for causing the host vehicle to travel such that the host vehicle maintains a predetermined target distance from the following target object (S325, S350), and
the controller is configured not to execute the acceleration control in the following travel control (S330, S335, S340) when the following target object is a pedestrian during execution of the following travel control (S230, S240).

According to this aspect, when a pedestrian appears ahead of the host vehicle and the pedestrian is the following target object during the execution of the following travel control, the host vehicle is not accelerated for the pedestrian. Therefore, safety for the pedestrian can be improved and the situation in which the deceleration control is executed after the acceleration control does not occur. Thus, it is possible to prevent the case where the occupant of the host vehicle is given an anxiety or a sense of discomfort.

In the vehicle control device according to the aspect of the present disclosure, the controller is configured to, when the forward information indicates a strong possibility that the host vehicle collides with an object located ahead of the host vehicle during the execution of the following travel control (S315: Yes), cancel the following travel control (S365) and execute collision avoidance control for avoiding a collision between the host vehicle and the pedestrian (S370).

According to this aspect, it is possible to reduce the possibility that the host vehicle and the pedestrian come into contact with each other.

In the above description, in order to facilitate understanding of the present disclosure, names and/or signs used in the following embodiment are added in parentheses to the configurations of the disclosure corresponding to those of the embodiment. However, the components of the present disclosure are not limited to those of the embodiment defined by the names and/or signs. The present disclosure also encompasses a vehicle control method and a storage medium.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle control device according to an embodiment of the present disclosure;

FIG. 2 is a routine executed by CPU of the vehicle control ECU shown in FIG. 1;

FIG. 3 is a routine executed by CPU of the vehicle control ECU shown in FIG. 1;

FIG. 4 is a routine executed by CPU of the vehicle control ECU shown in FIG. 1; and

FIG. 5 is a routine executed by CPU of the variation of the vehicle control ECU shown in FIG. 1.

### DETAILED DESCRIPTION OF EMBODIMENTS

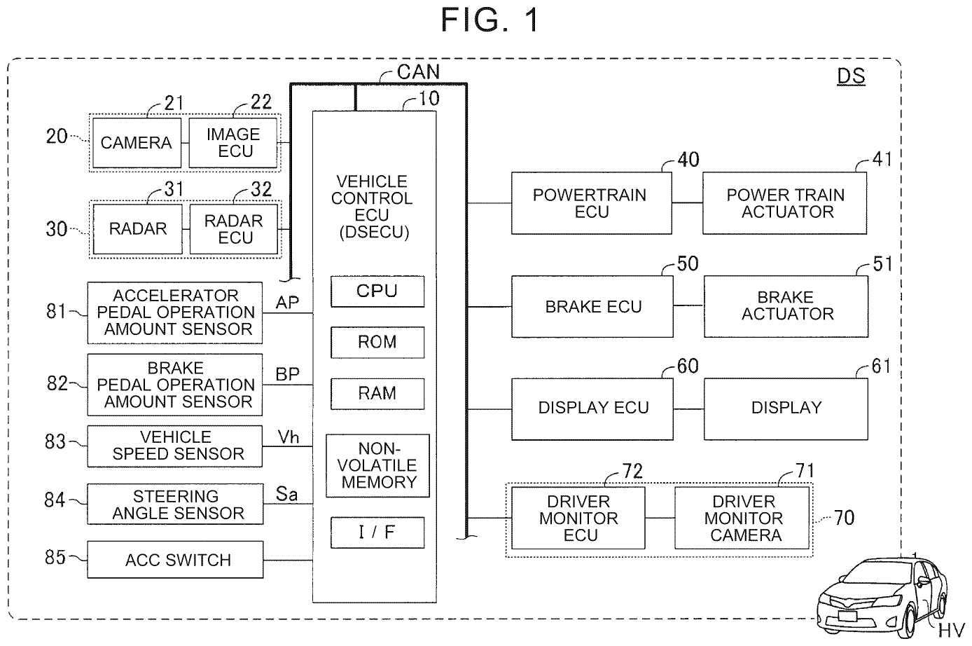

“Vehicle control device DS (hereinafter referred to as “device DS”) according to an embodiment of the present disclosure includes components illustrated in FIG. 1. The device DS is applied to the host vehicle HV. The host vehicle HV may be any of a vehicle equipped with an internal combustion engine, a battery electric vehicle, a hybrid electric vehicle, and the like.

As used herein, an “ECU” is an electronic control unit that includes a microcomputer that includes a CPU (processor), a ROM, RAM, and non-volatile memory (storage medium) to which data and a program are writable. ECU are also referred to as controllers or computers. The plurality of ECU shown in FIG. 1 are connected to each other through a CAN (Controller Area Network) so as to be able to exchange information. Some or all of these ECU may be integrated into one ECU.

The vehicle control ECU 10 transmits and receives signals to and from the components shown in FIG. 1. The vehicle control ECU 10 is also referred to as a driving assistance ECU. The vehicle control ECU 10 is hereinafter referred to as “DSECU”. DSECU performs driving assistance control. The driving assistance control includes an adaptive cruise control (hereinafter, referred to as “ACC”). ACC includes acceleration control for accelerating the host vehicle HV, deceleration control for decelerating the host vehicle HV, and constant speed control for maintaining the speed of the host vehicle HV at a constant speed.

The camera device 20 includes a camera 21 and an image ECU 22. Each time a predetermined period of time elapses, the camera 21 acquires image data representing an image in front of the host vehicle HV. The image ECU 22 generates camera-object data based on the image data. The camera target information includes a “position and type” of a target existing in front of the host vehicle HV. The types of targets include other vehicles, motorcycles, pedestrians, etc.

The radar device 30 is a well-known device that acquires information about a target object existing in front of the host vehicle HV by using a millimeter-wave band radio wave. The radar device 30 includes a radar device 31 and a radar ECU 32. Each time a predetermined time elapses, the radar device 31 transmits millimeter waves within a predetermined detection range and receives millimeter waves reflected by the target object. The radar ECU 32 acquires radar target information based on information about millimeter waves transmitted and received by the radar device 31. The radar target information includes a distance to the target, an orientation of the target, a relative velocity of the target, and the like.

DSECU integrates the camera-target information and the radar-target information to generate final target information (i.e., fusion target information). Therefore, the camera device 20 and the radar device 30 constitute an object information acquisition device that acquires forward information regarding a situation (an object, a road sign, and the like) in front of the host vehicle. The fusion target information is also referred to as forward information.

The powertrain ECU 40 drives the powertrain actuator 41 in response to an instruction from DSECU or an operation of the accelerator pedal by the driver. As a result, the powertrain ECU 40 adjusts the driving force generated by the driving device (the internal combustion engine, the electric motor, and the like) of the host vehicle HV to control the acceleration of the host vehicle HV.

The braking ECU 50 drives the brake actuator 51 in response to an instruction from DSECU or an operation of the brake pedal by the driver. Thus, the braking ECU 50 adjusts the braking force generated by the braking device on the host vehicle HV, and controls the deceleration (negative acceleration) of the host vehicle HV.

The display ECU 60 performs predetermined display on the display 61 in response to an instruction from DSECU.

The driver monitoring device (driver monitor) 70 is a device that acquires driver information that is information indicating the state of the driver of the host vehicle HV (that is, the driver state of the host vehicle). The driver information includes a line-of-sight direction of the driver of the host vehicle HV and a facial direction of the driver. The driver monitoring device 70 includes a driver monitor camera 71 and a driver monitor ECU 72, and is disclosed in, for example, Japanese Unexamined Patent Application Publication No. 2019-87029 (JP 2019-87029 A) and Japanese Unexamined Patent Application Publication No. 2013-152700 (JP 2013-152700 A).

The driver monitor camera 71 photographs the face of the driver of the host vehicle HV every time a predetermined period of time elapses to generate face image data. The driver monitor ECU 72 acquires the driver information based on the facial image data transmitted from the driver monitor camera 71, and transmits the driver information to the vehicle control ECU 10.

DSECU receives the detected values or the outputted values of the “sensors and switches” below.
An accelerator pedal operation amount sensor 81 that detects an accelerator pedal operation amount A P of the host vehicle HV.
A brake pedal operation amount sensor 82 that detects a brake pedal operation amount BP of the host vehicle HV.
Vehicle speed sensor 83 that detects the speed of the host vehicle HV (that is, the host vehicle speed Vh).
A steering angle sensor 84 for detecting a steering angle Sa of the host vehicle HV.
ACC switch 85 is an operating switch for giving an instruction to ACC. ACC switch 85 includes an on switch, a cancel switch and a resume switch or the like.

### Overview of Operation

The device DS executes ACC as driving assistance control. ACC includes “following travel control and constant speed travel control” which are both well known. The following travel control is also referred to as following inter-vehicle distance control. The following travel control includes an automatic start control.

The following travel control is a control for maintaining the distance between the following target object and the host vehicle in the predicted traveling region of the host vehicle and immediately before the host vehicle at a predetermined target distance. Therefore, in the following travel control, the host vehicle is accelerated, decelerated, or traveled at a constant speed in accordance with the speed change of the subject target. That is, the following travel control includes acceleration control, deceleration control, and constant speed control. The following target object is often another vehicle. However, in some cases, a pedestrian including a runner may be selected as a following target object.

The automatic start control is a control for starting the host vehicle when the host vehicle stops after the following target object stops during the execution of the following travel control and the following target object starts thereafter. Therefore, the acceleration control is executed in the automatic start control, and the host vehicle is accelerated.

The constant speed travel control is a control for maintaining the host vehicle speed at a predetermined target speed. Therefore, in the constant speed travel control, for example, the host vehicle is accelerated, decelerated, or traveled at a constant speed in accordance with a road gradient. That is, the constant speed travel control includes acceleration control, deceleration control, and constant speed control.

Incidentally, when the host vehicle is traveling at an extremely low speed by the following travel control or the constant speed travel control, the runner may appear in front of the host vehicle in some cases. When the runner is selected as the following target object, when the speed of the runner is higher than the speed of the host vehicle, the host vehicle may be accelerated by the following travel control. As a result, since the host vehicle and the runner approach each other, there is a possibility that the deceleration control is started.

Therefore, the device DS determines whether or not a pedestrian is present in the predicted traveling trajectory of the host vehicle and the vicinity thereof, based on the fusion target data. The predicted traveling locus of the host vehicle and its vicinity are hereinafter referred to as “predicted traveling region”. When a pedestrian is present in the predicted traveling region and the pedestrian is selected as the following target object, the device DS prohibits the host vehicle from being accelerated during the execution of the following traveling control. That is, the device DS may determine that a pedestrian is present in a predicted traveling region ahead of the host vehicle during the following travel control. In this case, the device DS inhibits the acceleration control required for the following travel control and permits the constant speed control and the deceleration control required for the following travel control, thereby suppressing acceleration of the host vehicle. Therefore, since the host vehicle is not accelerated toward the pedestrian located in front of the vehicle, a situation in which the host vehicle is accelerated with respect to the pedestrian and then decelerated does not occur. Therefore, the device DS can reduce the possibility of giving the driver an anxiety or a sense of discomfort during the following travel control as the driving assistance control.

### Specific Operation

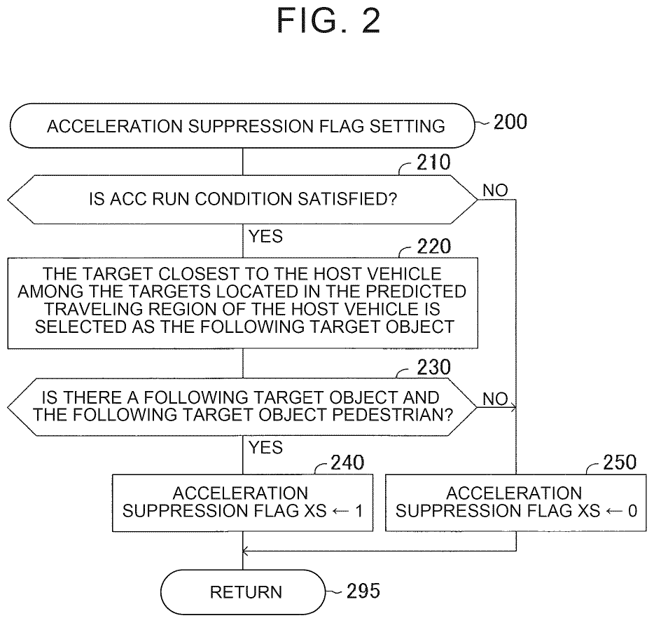

CPU of DSECU executes the routines illustrated in FIGS. 2 to 4 every time a predetermined period (calculation cycle) dt elapses. In the following description, “step” is referred to as “S”.

### Acceleration Suppression Flag Setting

At a predetermined timing, CPU proceeds from S200 of FIGS. 2 to S210 to determine whether or not ACC is currently executed. ACC is executed, for example, when the host vehicle speed Vh is equal to or lower than the high speed threshold VHth (for example, 120 km/h), the brake pedal operation amount BP is “0”, and ACC switch 85 is in the on-state.

If ACC execution-condition is satisfied, CPU proceeds from S210 to S220. In S220, CPU selects the following target object based on the fusion target information. The following target object is a target closest to the host vehicle among the targets existing in the predicted traveling region of the host vehicle. The following target object is, for example, a single “other vehicle, motorcycle, pedestrian, or the like”. The predicted traveling region is included in a region in front of the host vehicle, and the center line is a line through which the center of the front end portion of the host vehicle passes. CPU acquires the center line of the predicted traveling region based on the current steering angle Sa of the host vehicle. The left dividing line of the predicted traveling region is a line through which a point shifted by a predetermined distance (for example, 30 cm) leftward from the left front end of the host vehicle passes. The right division line of the predicted traveling region is a line through which a point shifted by a predetermined distance (for example, 30 cm) is passed from the right front end portion of the host vehicle to the right. The space between the left-side division line and the right-side division line is a predicted traveling region. The length of the center line of the predicted traveling region is, for example, about 200 m.

Next, CPU proceeds to S230 to determine whether the following object is present and whether the following object is a pedestrian based on the fusion target information. If the following object is present and the following object is a pedestrian, CPU proceeds from S230 to S240. In S240, CPU sets the acceleration suppression flag XS to “1”. CPU then proceeds to S295 and tentatively terminates the routine.

On the other hand, if there is no tracking object or if there is a tracking object but the tracking object is not a pedestrian, CPU proceeds from S230 to S250. In S250, CPU sets the acceleration suppression flag XS to “0”. CPU then proceeds to S295. If ACC execution-condition is not satisfied, CPU proceeds from S210 to S295 through S250.

### ACC

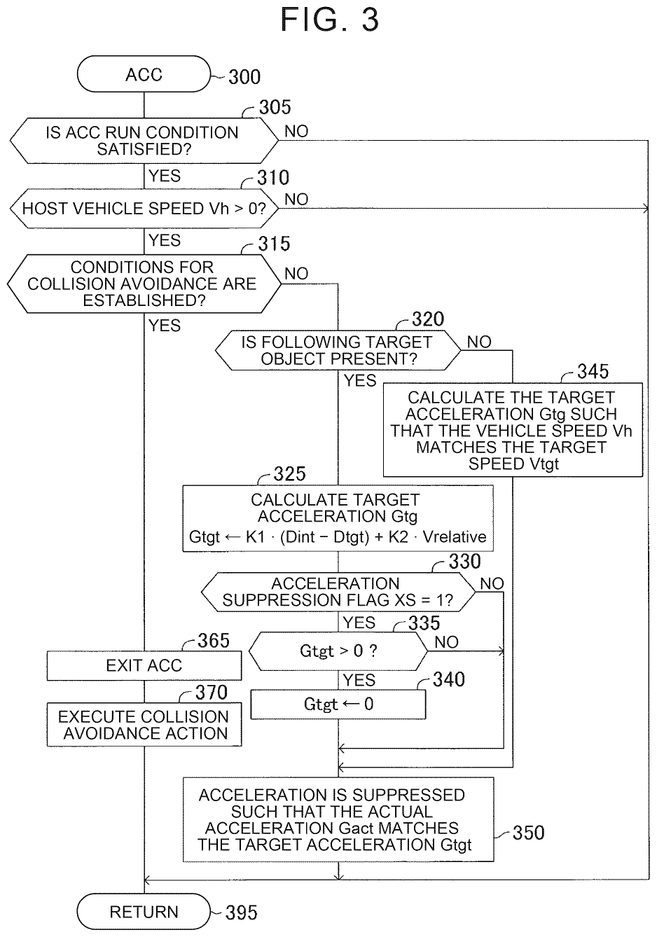

At a predetermined timing, CPU proceeds from S300 of FIGS. 3 to S305 to determine whether or not ACC is currently executed. If ACC execution-condition is satisfied, CPU proceeds to S310. In S310, CPU determines whether or not the host vehicle speed Vh is greater than “0”. That is, CPU determines whether or not the host vehicle is traveling.

When the host vehicle speed Vh is greater than “0”, CPU proceeds to S315 and determines whether or not the collision-avoidance condition is satisfied. That is, CPU determines whether or not the fusion target information (that is, the forward information) indicates that the object located in front of the host vehicle and the host vehicle are likely to collide with each other. The object includes a pedestrian. More specifically, CPU calculates a time (i.e., collision prediction time) TTC until the host vehicle reaches an object existing in the predicted traveling region of the host vehicle by dividing the distance between the host vehicle and the object by the relative velocity of the object. Then, CPU determines whether or not the collision-predicted time TTC is equal to or less than the threshold-time TTCth.

If the predicted collision time is greater than the threshold time TTCth, CPU determines that the collision avoidance condition is not satisfied and proceeds to S320. In S320, CPU determines whether or not there is a following target object.

If there is a following target object, CPU proceeds to S325. In S325, CPU calculates the “target acceleration Gtgt of the host vehicle HV” for causing the distance Dint between the following target object and the host vehicle to coincide with the predetermined target distance Dtgt according to Expressions 1 and 2 below. The target distance Dtgt is equal to the product of the host vehicle speed Vh and the predetermined inter-vehicle time Tint when the host vehicle speed Vh is equal to or higher than the low-speed vehicle speed threshold VLth. The target distance Dtgt is set to a value that decreases as the vehicle speed Vh decreases when the vehicle speed Vh is less than the low-speed vehicle speed threshold VLth. V relative in Equation 2 is the velocity of the following target object with respect to the host vehicle. The relative-velocity V relative is positive when the following target object is moving away from the host vehicle. K1 and K2 are predetermined positive gains (factors). Thereafter, CPU proceeds to S330.

$$Distance deviation Δ D = actual distance Dint - target distance Dtgt \qquad ( 1 )$$

$$Target acceleration Gtgt = K 1 \cdot Δ D + K 2 \cdot Vrelative \qquad ( 2 )$$

In S330, CPU determines whether or not the acceleration suppression flag XS is “1”. As described above, the acceleration suppression flag XS is set to “1” when the following object is present and the following object is determined to be a pedestrian.

If the acceleration suppression flag XS is “1”, CPU proceeds to S335 and determines whether or not the target acceleration Gtgt calculated by S325 is greater than “0”. That is, CPU determines whether or not the target acceleration Gtgt is for accelerating the host vehicle.

If the target acceleration Gtgt is greater than “0”, CPU proceeds to S340 and sets the target acceleration Gtgt to “0”. As a result, acceleration of the host vehicle is suppressed (prohibited) in S350 described later. CPU then proceeds to S350. On the other hand, when the target acceleration Gtgt is equal to or less than “0”, CPU proceeds directly from S335 to S350. When the following object is present and the following object is determined to be a pedestrian by these processes, the acceleration control in the following travel control is not performed, and the constant speed control and the deceleration control in the following travel control are allowed. Therefore, the host vehicle is not accelerated toward the pedestrian selected as the following target object, and therefore is not decelerated after the host vehicle is accelerated with respect to the pedestrian.

If CPU proceeds to S330, CPU proceeds from S330 to S350 when the acceleration suppression flag XS is not “1”.

On the other hand, when CPU proceeds to S320 and there is no following target object, CPU proceeds from S320 to S345. In S345, CPU calculates the “target acceleration Gtgt of the host vehicle HV” for matching the host vehicle speed Vh with the predetermined target vehicle speed Vtgt in accordance with a known method. For example, when the vehicle speed Vh is lower than the target vehicle speed Vtgt, the target acceleration Gtgt is set to a positive predetermined value GP. When the vehicle speed Vh is higher than the target vehicle speed Vtgt, the target acceleration Gtgt is set to a negative predetermined value GM. When the host vehicle speed Vh matches the target vehicle speed Vtgt, the target acceleration Gtgt is set to “0”. CPU then proceeds to S350.

In S350, CPU transmits an instruction to the powertrain ECU 40 and the braking ECU 50 to control the acceleration of the host vehicle so that the actual acceleration Gact of the host vehicle matches the target acceleration Gtgt. CPU calculates the actual acceleration Gact of the host vehicle from the variation of the host vehicle speed Vh per unit time. CPU then proceeds to S395 to tentatively terminate the routine.

Furthermore, when CPU determines “No” in S305 and “No” in S310, CPU proceeds directly from the steps in which determination is “No” to S395.

In addition, CPU proceeds from S315 to S365 when the collision predicted time TTC is less than or equal to the threshold time TTCth when CPU proceeds to S315, and thus the collision avoidance condition is satisfied, and ACC ends. CPU then proceeds to S370 and executes the known automated braking control (collision mitigation braking) as collision avoidance control by sending instructions to the powertrain ECU 40 and the braking ECU 50. That is, CPU stops the host vehicle so that the host vehicle does not collide with an object (including a pedestrian) existing in the predicted traveling region. CPU then proceeds to S395.

Note that CPU may perform auto-steering control for automatically changing the steering angle of the host vehicle as the collision avoidance control so that the host vehicle and the object (including the pedestrian) do not collide with each other in S370. Further, CPU may perform the alert control as the collision avoidance control by transmitting an instruction to the display ECU 60 in S370. That is, CPU may perform at least one of a display control for displaying a display indicating the presence of a pedestrian to a driver of the host vehicle on a display, and an alarm sound generation control for generating an alarm sound from a speaker (not shown). The alarm control may be performed in addition to or independently of the automatic braking control and/or the automatic steering control.

### Automatic Start Control

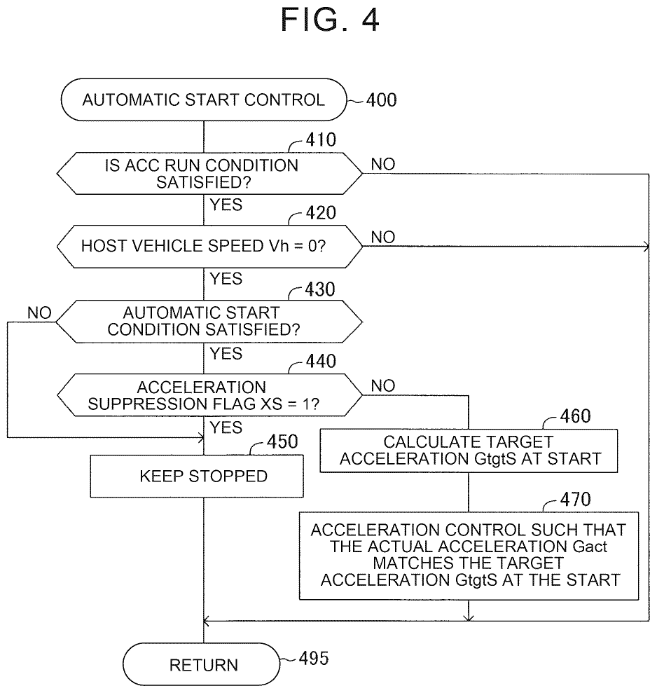

At a predetermined timing, CPU proceeds from S400 of FIGS. 4 to S410 to determine whether or not ACC is currently executed. If ACC execution-condition is satisfied, CPU proceeds to S420. In S420, CPU determines whether or not the host vehicle speed Vh is “0”. That is, CPU determines whether or not the host vehicle continues to be stopped.

When the vehicle speed Vh is “0”, CPU proceeds from S420 to S430 and determines whether or not the auto-start condition is satisfied at the present time. For example, when the following target object is another vehicle and the other vehicle stops, the host vehicle stops at the rear of the other vehicle. After that, when the other vehicle starts, the distance between the host vehicle and the other vehicle becomes larger than “the distance between the host vehicle and the other vehicle at the time when the host vehicle stops” by a predetermined distance or more. That is, the “distance between the host vehicle and the following target object” is larger than the “sum of the distance between the host vehicle and the following target object at the time when the host vehicle stops and the predetermined distance”. At this time, if at least one of the first condition and the third condition described below is satisfied, the automatic start condition is satisfied.
(First condition) The current time point is within a predetermined time period from the time point when the host vehicle stops.
(Second condition) The driver information acquired by the driver monitoring device 70 indicates that the driver is gazing forward.
(Third condition) ACC switch 85 was operated by the driver, resulting in the resume switch changing from an off state to an on state.

If the autostart condition is satisfied, CPU proceeds from S430 to S440. In S440, CPU determines whether or not the acceleration suppression flag XS is “1”.

When the acceleration suppression flag XS is “1”, CPU proceeds to S450 and maintains the host vehicle in the stopped condition. That is, the acceleration control is prohibited, and the host vehicle is not accelerated (started). CPU then proceeds to S495 to tentatively terminate the routine.

On the other hand, when the acceleration suppression flag XS is not “1”, CPU proceeds from S440 to S460 and calculates the starting target acceleration GtgtS. For example, CPU sets the starting target acceleration GtgtS to a positive constant value. Then, CPU proceeds to S470 and controls the acceleration of the host vehicle such that the actual acceleration Gact of the host vehicle matches the starting target acceleration GtgtS by transmitting an instruction to the powertrain ECU 40 and the braking ECU 50. Therefore, the host vehicle is accelerated (started). CPU then proceeds to S495 to tentatively terminate the routine.

When CPU determines that the auto start condition is not satisfied by S430, S450 proceeds directly from S430. As a result, the host vehicle is maintained in a stopped state. Further, if ACC execution-condition is not satisfied at the present time, CPU proceeds directly from S410 to S495. When the host vehicle speed Vh is not “0”, CPU proceeds from S420 to S495.

As described above, the device DS does not execute the acceleration control when the pedestrian is present in the predicted traveling region ahead of the host vehicle while the following traveling control as the driving assistance control is being executed. That is, the device DS does not execute the acceleration control when the pedestrian is selected as the following target object during the execution of the following travel control as the driving assistance control. Therefore, a situation in which the host vehicle is accelerated so as to approach the pedestrian does not occur. As a result, during the execution of the following travel control, the host vehicle is accelerated toward the pedestrian, and thereafter, the possibility that the host vehicle approaches the pedestrian and the host vehicle is decelerated is reduced.

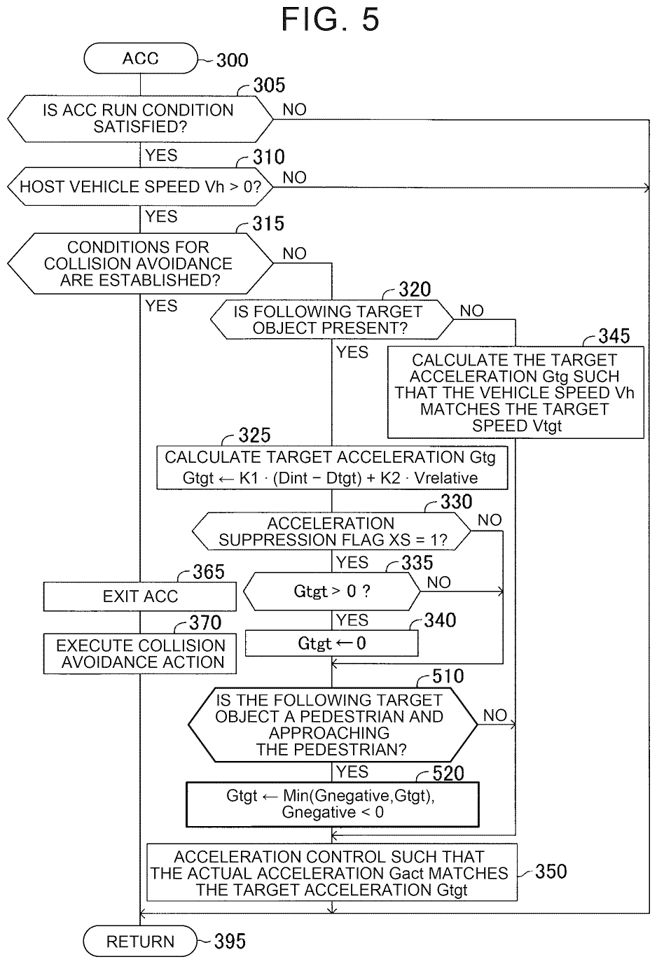

The present disclosure is not limited to the above-described embodiments, and various modifications can be adopted within the scope of the present disclosure. For example, CPU may execute the routine illustrated by the flow chart in FIG. 5 instead of FIG. 3. The routine illustrated in FIG. 5 is a routine obtained by adding S510 and S520 to the routine illustrated in FIG. 3.

More specifically, CPU proceeds to S510 in either a case where it is determined as “No” in S330, a case where it is determined as “No” in S335, or a case where S340 process is executed.

CPU determines in S510 whether or not the following target object is a pedestrian and the host vehicle is approaching the pedestrian. That is, when the pedestrian is selected as the following object, CPU determines whether or not the distance between the pedestrian and the host vehicle is decreasing. When the host vehicle is approaching the pedestrian which is the following target object, CPU proceeds to S520. In S520, CPU sets the target acceleration Gtgt to the smaller one of the predetermined negative value Gnegative and the target acceleration Gtgt determined at the present time. Min(a,b) represents a function for selecting a smaller value from among the variable a and the variable b. CPU then proceeds to S350. On the other hand, when the host vehicle is not approaching the pedestrian selected as the following target object, CPU proceeds directly from S510 to S350.

The target acceleration Gtgt calculated by S325 can take a positive value when the distance between the pedestrian as the following target object and the host vehicle is considerably distant from each other even when the host vehicle speed Vh is higher than the speed of the pedestrian as the following target object. The case where the host vehicle speed Vh is higher than the speed of the pedestrian which is the following target object, that is, the case where the relative speed V relative is negative. The case where the distance between the pedestrian serving as the following target object and the host vehicle is considerably distant from each other is a case where the distance deviation ΔD is considerably large. At this time, although the target acceleration Gtgt is set to “0” by the processes of S330 to S340, the host vehicle approaches the pedestrian because the host vehicle speed Vh is higher than the speed of the pedestrian that is the following target object. Even in such cases, the target acceleration Gtgt is always negative by S510 and S520 processes, and thus the host vehicle HV is always decelerated. Therefore, according to this modification, since the host vehicle does not approach the pedestrian, which is the following target object, the safety can be further improved.

Furthermore, the present disclosure is also applicable to an automated driving vehicle that is in an automated driving state or an automated driving vehicle in a state in which the driving mode is transitioned from automated driving to manual driving by a driver. Further, the forward information acquisition device may include only the camera device 20. The forward information acquisition device may include a LiDAR.

In addition, DSECU may determine whether or not the traffic light in front of the host vehicle has changed from red to blue based on the image data acquired by the camera 21, and determine that the auto-start condition is satisfied when the traffic light has changed from red to blue, thereby performing acceleration control. Also in this case, when the pedestrian is present in the predicted traveling region ahead of the host vehicle, DSECU prohibits the acceleration control.

What is claimed is:

1. A vehicle control device comprising:
a forward information acquisition device configured to acquire forward information related to a state ahead of a host vehicle; and
a controller configured to execute driving assistance control including acceleration control for accelerating the host vehicle and deceleration control for decelerating the host vehicle, wherein
the controller is configured not to execute the acceleration control when the forward information indicates that a pedestrian is located in a region ahead of the host vehicle during execution of the driving assistance control.

2. The vehicle control device according to claim 1, wherein:
the controller is configured to, as the driving assistance control, select an object located in a predicted traveling region ahead of the host vehicle where the host vehicle is predicted to travel as a following target object, and execute, based on the forward information, following travel control for causing the host vehicle to travel such that the host vehicle maintains a predetermined target distance from the following target object; and
the controller is configured not to execute the acceleration control in the following travel control when the following target object is a pedestrian during execution of the following travel control.

3. The vehicle control device according to claim 2, wherein the controller is configured to, when the forward information indicates a strong possibility that the host vehicle collides with an object located ahead of the host vehicle during the execution of the following travel control, cancel the following travel control and execute collision avoidance control for avoiding a collision between the host vehicle and the pedestrian.

4. A vehicle control method for executing driving assistance control including acceleration control for accelerating a host vehicle, deceleration control for decelerating the host vehicle, and constant speed control for maintaining a speed of the host vehicle at a constant speed, the vehicle control method comprising:
a step of acquiring forward information related to a state ahead of the host vehicle during execution of the driving assistance control; and
a step of continuing the driving assistance control while not executing the acceleration control when the forward information indicates that a pedestrian is located ahead of the host vehicle.

5. A non-transitory storage medium storing a program to be executed by a computer mounted on a host vehicle, the program causing the computer to execute:
a step of executing driving assistance control including acceleration control for accelerating the host vehicle, deceleration control for decelerating the host vehicle, and constant speed control for maintaining a speed of the host vehicle at a constant speed;
a step of acquiring forward information related to a state ahead of the host vehicle during execution of the driving assistance control; and
a step of continuing the driving assistance control while not executing the acceleration control when the forward information indicates that a pedestrian is located ahead of the host vehicle.
